(19) United States
(12) Patent Application Publication
(10) Pub. No.: US 2016/0031379 A1
(43) Pub. Date: Feb. 4, 2016

(54) CUP HOLDER GUN HOLSTER

(71) Applicant: Roderick Dale Duncan, Athens, GA (US)

(72) Inventor: Roderick Dale Duncan, Athens, GA (US)

(21) Appl. No.: 14/445,763

(22) Filed: Jul. 29, 2014

(51) Int. Cl. B60R 7/14

(52) U.S. Cl. CPC B60R 7/14

(57) ABSTRACT

A holster for receiving and holding a handgun and that can be placed in a cup-holder. The holster includes a base that is structured to fit into a cup-holder and that defines a cavity for receiving a portion of the handgun. A barrel support element is positioned within the cavity of the base and a top is positioned on the base and defines an opening into the interior. through which the barrel of the handgun can penetrate when being positioned into the barrel support element. In operation, the base is configured to be inserted into a cup-holder of a vehicle and thus operate to provide storage for a handgun but, also provide easy access to the handgun.

### BACKGROUND

The odds are that an individual may make it through life without ever being the victim of a violent crime or other crime. However, there are a substantial number of individuals that are not so fortunate. The second amendment to the United States constitution protects the right of individual to keep and to bear arms. However, it will be appreciated that in a typical scenario, the need to utilize a weapon, such as a handgun, may come on rather quickly and as such, an individual may not have time to react to the circumstances to retrieve and utilize the weapon. For instance, consider the situation of lady pulling up to a downtown traffic light in clean and shiny BMW. As the light turns yellow she realizes that she is going to need to come to a stop as the light will certainly be red before she arrives at the solid white line. And so, she begins to slow down and, the car in front of her does the same thing. As she comes to a stop, she briefly looks up and adjusts the rear view mirror to see the kids in the back seat. With her arm in the air and her eyes focuses on the kids, she does not notice the passenger door of the vehicle in front of her open as a man with a hoodie jumps out and shuts the door behind him. He quickly rushes around her car and reaches into the window to grab her shoulders as he opens the door. She quickly tries to bend down and reach for the gun under her seat. She feels the cool handle of the gun but before she can get her hands around it, the man drags her out of the car and throws her to the street. He jumps into the car and slams the door as he and the car in front of him bust through the red light and disappear into the traffic.

One will appreciate that this scenario can be created because of competing interests or concerns. The greater access that is provided to a handgun, such as in a moving automobile, the greater the risk is to others within the vehicle. For instance, one could simply lay a handgun on the passenger seat but, an abrupt start could send the handgun flying to the floor and result in a discharge of the weapon. Such an incident could easily cause damage, injury or even death. But on the other hand, placing the handgun into a glove box or other more secure environment may result in the occurrence of the above-described scene. What is needed in the art is a technique to enable an individual to strike a balance between accessibility and safety.

### BRIEF SUMMARY

In general, the various embodiments of the cup-holder handgun holster include a base that defines an interior void. The various embodiments include an aperture providing access to the interior void and a support structure for providing additional stability in holding a device inserted into the interior void. Thus, for instance, the barrel of a handgun can be inserted through the aperture, into the interior void and then supported in position by the support structure. A wide variety of embodiments are illustrated and described and the present invention is not limited to any particular embodiment or configuration but, as a non-limiting example, and exemplary embodiment includes a base, a top and a barrel support structure.

Thus, an exemplary embodiment includes an apparatus for receiving and holding a handgun. The apparatus includes a base that defines a cavity for receiving a portion of the handgun. A barrel support element is positioned within the cavity of the base and is immobile in relationship to the base. Finally a top is positioned above the base and the top defines an aperture through which the barrel of the handgun can penetrate when being positioned into the barrel support element. In operation, the base is configured to be inserted into a cup-holder of a vehicle and thus operate to provide storage for a handgun but, also provide easy access to the handgun.

In addition, the present disclosure presents a process for storing of a handgun in a manner that provides easy access. The process includes placing a base into a cup-holder wherein the base defines an interior cavity. A barrel support is inserted into the interior cavity of the base and secured into position. A top is placed onto the base and secured into position. The top defines an aperture through which a barrel of a handgun can penetrate through and to provide access to the barrel support. A handgun can then be placed into the holster through the aperture of the top such that the barrel enters the interior cavity of the base and is held in position by the barrel support.

These and other embodiments of the cup-holder handgun holster are presented in more detail with reference to the drawings and the detailed description.

### BRIEF DESCRIPTION OF THE SEVERAL VIEWS OF THE DRAWING

FIG. 1 is a conceptual diagram of an exemplary embodiment of a cup-holder gun holster.

FIG. 2 is a conceptual diagram of an exemplary embodiment of a base for a cup-holder gun holster, such as the embodiment presented in FIG. 1, as a non-limiting example.

FIG. 3 is a conceptual diagram of an exemplary embodiment of a top that can be mounted to the holster of FIG. 2 or other embodiments.

FIG. 4A is a top plan view of an exemplary embodiment of a top suitable for embodiments of the holster.

FIG. 4B is a top plan view of an exemplary embodiment of a top suitable for embodiments of the holster.

FIG. 5A is a top plan view of another exemplary embodiment of a top suitable for embodiments of the holster.

FIG. 5B is a top plan view of yet another exemplary embodiment of a top suitable for embodiments of the holster.

FIG. 6A is a top plan view of another exemplary embodiment of a holster.

FIG. 6B is a top plan photograph of the same embodiment presented in FIG. 6A with the top removed.

FIG. 7 is a side elevation view of an embodiment of the holster.

FIG. 8 is the side elevation view of the embodiment of the holster of FIG. 7 shown with hidden lines illustrating the detail of an embodiment of the interior cavity.

FIG. 9A and FIG. 9B illustrate a top plan view and a side elevation view of an exemplary interior of a base that can be incorporated into various embodiments of the holster.

FIG. 10A and FIG. 10B is another embodiment of a barrel support structure.

FIG. 11 is a perspective view of an exemplary embodiment of the holster with a handgun inserted into the holster.

FIG. 12 is a conceptual diagram of another embodiment of the holster.

FIG. 13 is yet another embodiment of the holster.

FIG. 14 is an illustration of another feature that may be incorporated into various embodiments of the handgun holster.

FIG. 15 is a flow diagram illustrating a method for storing a handgun within a vehicle.

### DETAILED DESCRIPTION OF EMBODIMENTS OF THE INVENTION

The present invention, as well as features and aspects thereof, is directed towards providing cup-holder gun holster. As the name implies, the various embodiments are directed to a holster for holding a gun and, a holster that exploits the use of cup-holders that may exist within the interior of a vehicle, such as a passenger car, boat and bus as a few non-limiting examples. The general concept of the various embodiments is the utilization of a container or base that can interface with or be inserted into the void of a cup-holder. The base generally defines an interior void into which the barrel portion of a handgun can be entered. When the base is placed within the cub-holder and the barrel of the handgun is inserted into the void of the base, the apparatus can securely and safely hold the handgun in position yet, provide easy access to the handgun for emergencies. Turning now to the figures, various embodiments of the cup-holder gun holster, as well as features, aspects and advantages thereof are described in greater detail. It should be appreciated that although the various embodiments are being presented and described as holsters for a handgun, the same principles of the present invention may equally be applied in a variety of other applications such as a tool holder, a bottle holder, a can holder for the taller more slender style cans such as REDBULL branded drinks, a stand for a mobile telephone, a stand for an electronic appliance (television screen, DVD player etc.) as well as a variety of other objects.

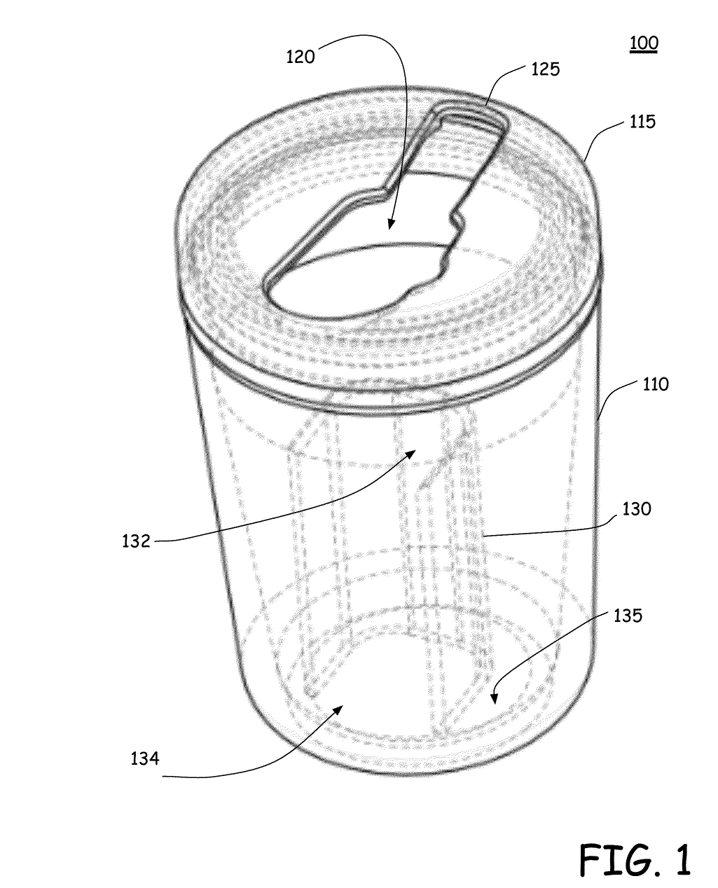

FIG. 1 is a conceptual diagram of an exemplary embodiment of a cup-holder gun holster. The cup-holder gun holster is referred to throughout this description as a holster. The illustrated embodiment of a holster 100 includes a base 110 and a top 115. The base 110 defines an interior void 120. The top 115 defines an aperture 125, which provides access to the interior void 120 when the top 115 is positioned on top of the base 110. As illustrated with broken lines, a barrel support 130 is shown as existing within the interior void 120 of the base 110. In the illustrated embodiment of the holster 100, the barrel support 130 is illustrated as being attached to, adjoined to, or integrally formed to be a part of the base 110 at a lower interior surface 135 of the base 110. In the illustrated embodiment, the barrel support 130 is shown as being rather C shaped thus allowing the bottom of the barrel to rest against the interior back edge 132 of the barrel support 130 while the top of the barrel can extend towards the open end 134 of the barrel support 130 It should be appreciated that in some embodiments, the top 115 can be placed onto the base by a snapping configuration, a threaded screw on configuration or be welded to the base as a few non-limiting examples. Thus, embodiments of the holster may include a removable top or a permanent top.

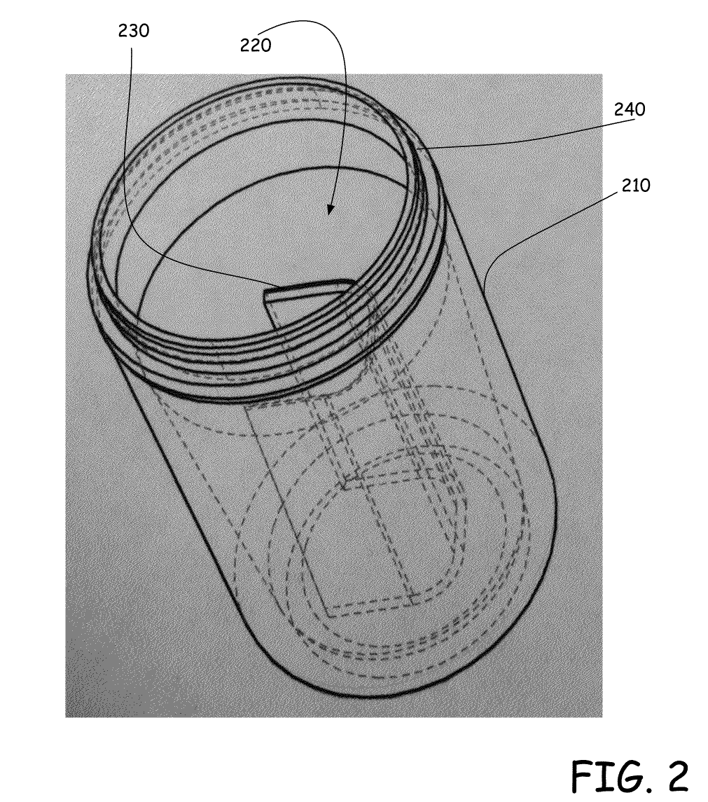

FIG. 2 is a conceptual diagram of an exemplary embodiment of a base for a cup-holder gun holster, such as the embodiment presented in FIG. 1, as a non-limiting example. In the illustrated embodiment, the base 210 is illustrated as including a snap interface 240 for receiving a top (not illustrated) but could also be threaded or utilize other technques. The base 210 defines an interior void 220 and is illustrated as including a barrel support 230.

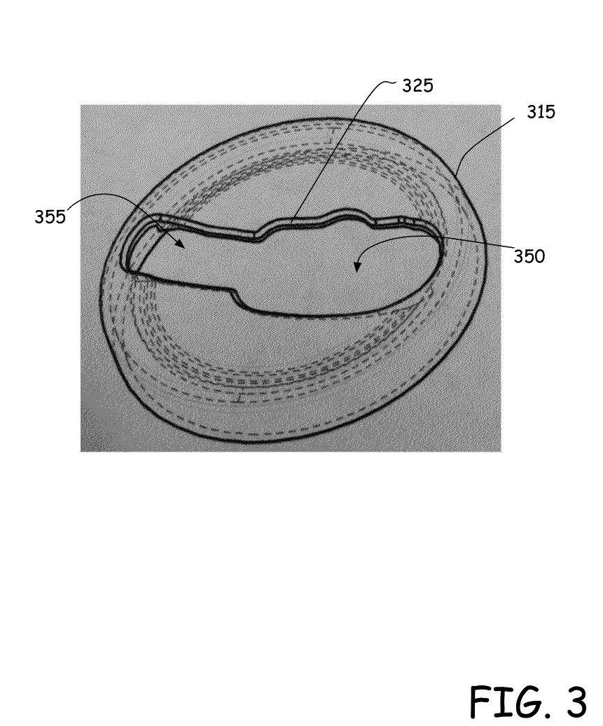

FIG. 3 is a conceptual diagram of an exemplary embodiment of a top that can be mounted to the holster of FIG. 2 or other embodiments. The top 315 can be configured with a snap on receptor for installation on base 210 of FIG. 2 or, in some other configuration to installation on a different type of base (the top 315 could also be threaded or use some other technique). The top 315 defines an opening or aperture 325 that in exemplary embodiments is designed to conform to the cross-sectional shape of the barrel of a handgun and trigger guard. For instance, in the illustrated embodiment, the aperture 325 includes an area 350 for receiving the barrel of a gun and an areal 355 for receiving a trigger guard.

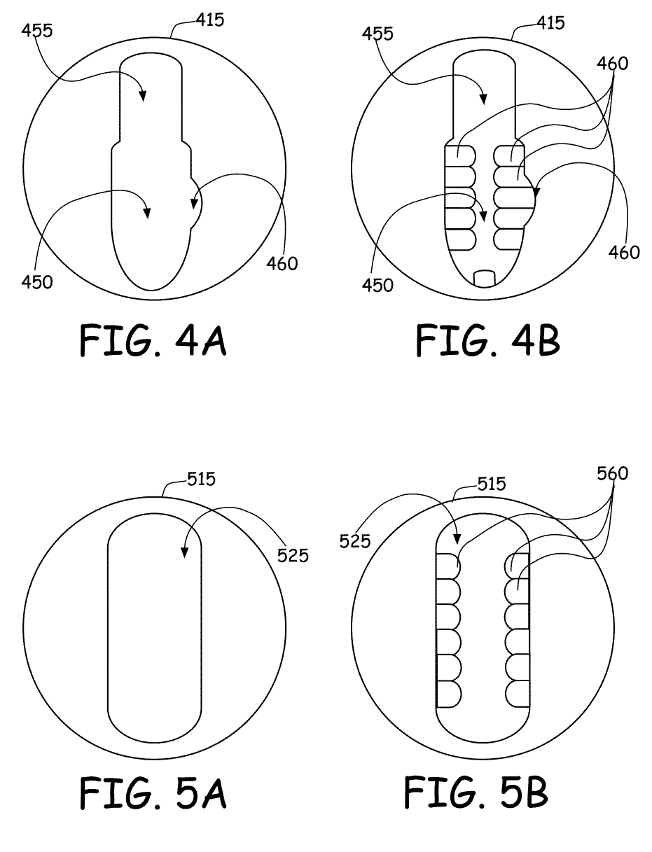

FIG. 4A is a top plan view of an exemplary embodiment of a top suitable for embodiments of the holster. The top 415 defines an aperture through which portions of a handgun can be inserted when storing the handgun into the holster. In the illustrated embodiment, the aperture includes an area 450 for receiving the profile of the barrel of the handgun, an areal 455 for receiving the trigger guard and the trigger of the handgun, and an area 460 that accommodates the magazine release of the handgun. Although the aperture 460 illustrated in this embodiment is applicable and suitable to work with a wide variety of handguns, it is appreciated that although this particular aperture may be included as an element in a claim, the present invention is not limited to any particular size and shape of the aperture.

FIG. 4B is a top plan view of an exemplary embodiment of a top suitable for embodiments of the holster. Similar to FIG. 4A, the illustrated embodiment includes the top 415 and an aperture including an area for the barrel of the handgun 450, the trigger guard and trigger 455 and the magazine release. However, in the illustrated embodiment one or more flanges 470 are included on the edge of the aperture. These flanges 470 are affixed, adjoined or integral to the top 415 and extend from the edges of the aperture towards the open areas of the aperture. In operation, as the barrel of the handgun is inserted through the aperture, the flanges are forced down but, are sufficiently rigid to provide a pressure or a force against the barrel of the handgun so as to provide support to the handgun making the fit snug within the aperture.

FIG. 5A is a top plan view of another exemplary embodiment of a top suitable for embodiments of the holster. In the illustrated embodiment, the top 515 defines a rather generic aperture 525. The illustrated embodiment shows how a single generic aperture 525 can be utilized to enable the various embodiments of the holster to work with a wide variety of handgun types.

FIG. 5B is a top plan view of yet another exemplary embodiment of a top suitable for embodiments of the holster. In the illustrated embodiment, the top of FIG. 5A has been augmented to include one or more flanges 560. Similarly to FIG. 4B, the flanges 560 operate to provide further support to hold the handgun. For the embodiments with a generic aperture 525, the use of the flanges 560 enables the generic aperture to be conformed to the contour of the handgun thus providing a more secure fit.

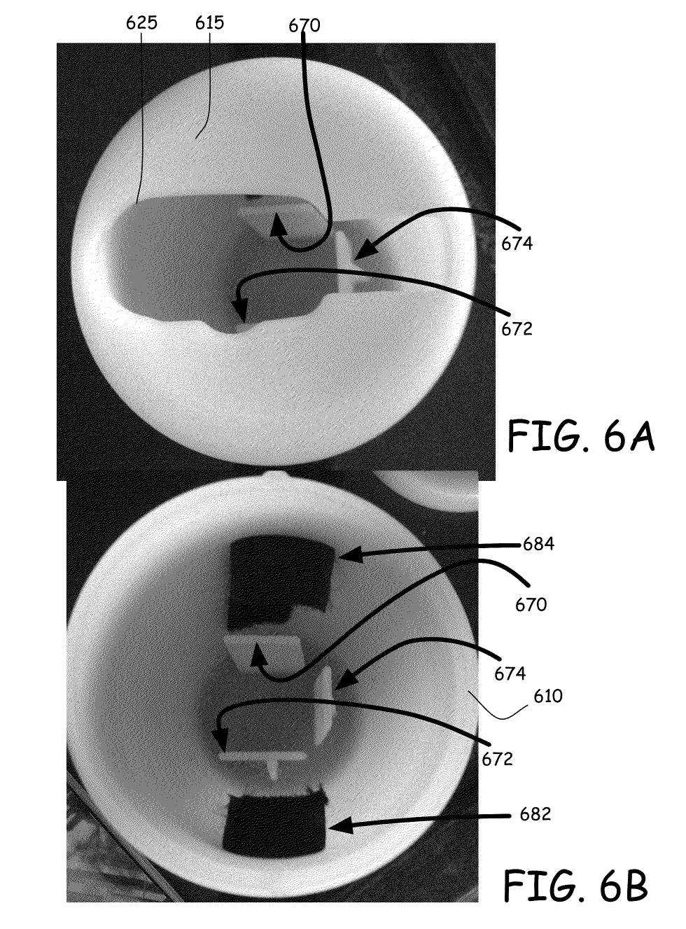

FIG. 6A is a top plan view of another exemplary embodiment of a holster. In the illustrated embodiment, the top 615 defines and aperture 625. Looking through the aperture 625, the barrel support can be seen as consisting of three vertically oriented wall surfaces extending upwards from the interior bottom surface of the base. The barrel support includes a right-side wall 670 and a left-side wall 672 that is substantially parallel to the right-side wall 670. In addition, a bottom-side wall 674 is substantially perpendicular to the right-side wall 670 and left-side wall 672 and is positioned on a plane that runs between the right-side wall 670 and left-side wall 672 but, is shifted outside of the gap between the same. Thus, the illustrated configuration is similar in function to the substantially “C” shaped barrel support 130 illustrated in FIG. 1. It should be appreciated that a wide array of configurations could be used for creating the barrel support and although one or more of the illustrated embodiments may in and of themselves and/or when combined with other elements may constitute patentable subject matter but, the present invention is not limited to any particular configuration.

FIG. 6B is a top plan photograph of the same embodiment presented in FIG. 6A with the top removed. In this view, the structure of the barrel support is more clearly visible. In addition, embodiments of the holster may also include a fastener or a securement device that can be used to further secure the handgun within the holster. As such, in the illustrated embodiment, the ends of two straps 682 and 684 are shown in the interior of the base 610. These straps can be inserted into slots on the side of the base and then clamped or hemmed into position or can be mounted to the outside of the base 610 as a few non-limiting examples. In operation, once a handgun is inserted into the holster, the straps 682 and 684 can then be joined at their opposing ends to secure the handgun using snaps, buckles loops and hooks or other techniques. In other embodiments, a single strap attached at both ends to the base 610 can be used and the strap can be elastic so as to stretch over the handgun and hold it in place. Other techniques may also be utilized to further secure the handgun into the holster.

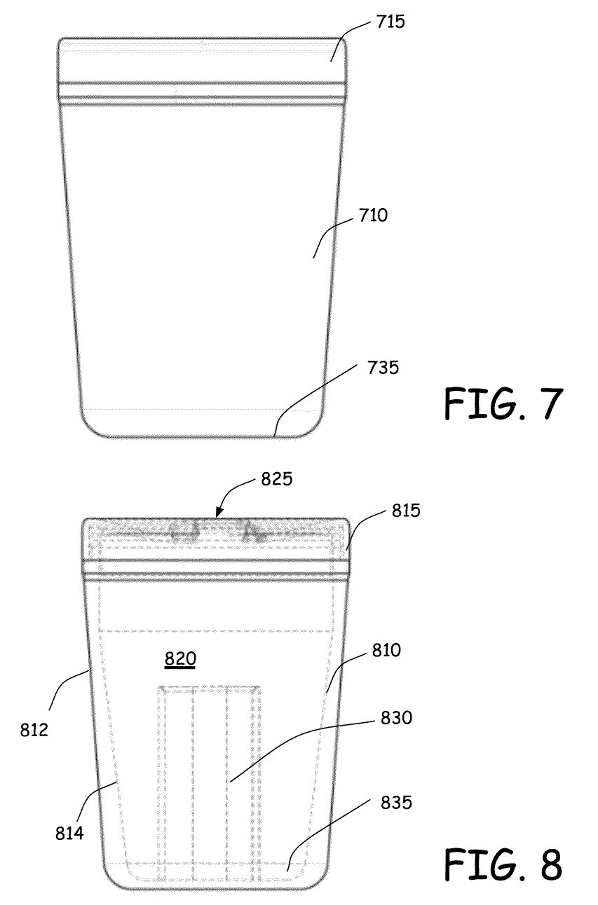

FIG. 7 is a side elevation view of an embodiment of the holster. In the illustrated embodiment, the holster 700 simply looks like a regular cup, glass or mug that can be inserted into a cup holder. The sides of the base 710 of the holster 700 are tapered towards the bottom 735 of the base 710 and the top 715 is shown as being attached to the base 710.

FIG. 8 is the side elevation view of the embodiment of the holster of FIG. 7 shown with hidden lines illustrating the detail of an embodiment of the interior cavity. The top 815 is shown as being secured to the base 810 and the exterior wall 812 and interior wall 814 of the base 810 taper towards the bottom surface 835 of the base 810. A barrel support 830 is shown as being located within the cavity 820. An aperture 825 passing through the lid 815 enables an object to be placed through the lid and into the cavity 820. The barrel support 830 then operates along with the walls or edges of the top 815 defining the aperture 825 to hold the object in position.

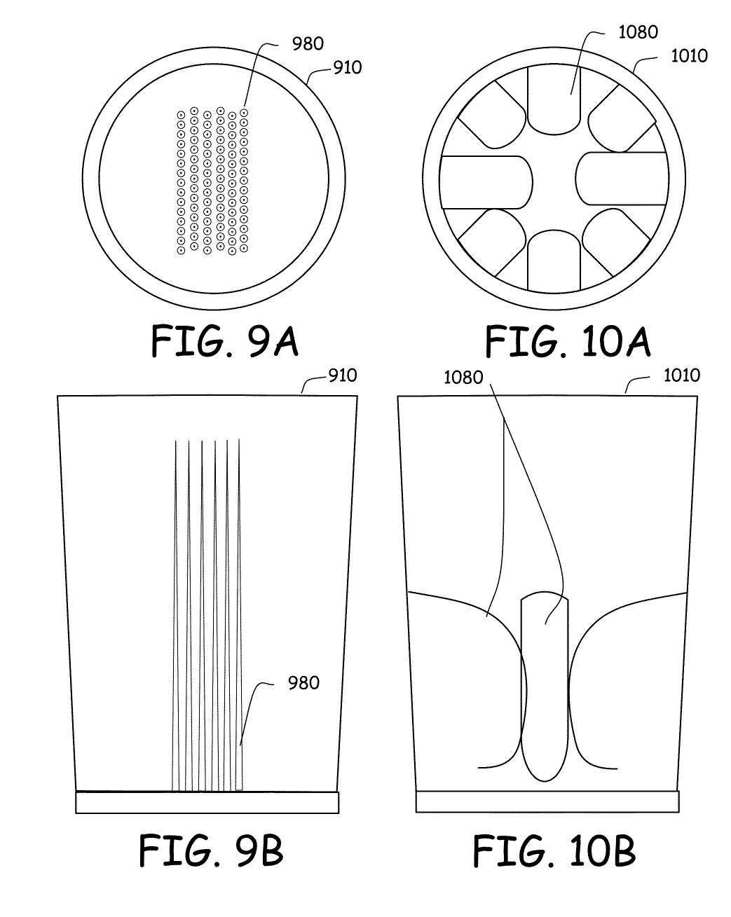

FIG. 9A and FIG. 9B illustrate a top plan view and a side elevation view of an exemplary interior of a base that can be incorporated into various embodiments of the holster. In the illustrated embodiment, the barrel support includes a series of rows of tall then spikes that are constructed of a flexible material but, that has sufficient strength to withstand some level of pressure. For instance, silicone rubber or other rubbers would be a suitable material for the spikes as a non-limiting example. The illustrated base 910 includes multiple rows of spikes 980. The spikes 980 can be fabricated into the base, secured to the base or secured to a plate that is then inserted into and/or secured to the base as a few non-limiting examples. The rigidity of the spikes 980 are such that when the barrel of a handgun is inserted through the aperture of the top, the barrel displaces the spikes 980, which in turn press up against the barrel and provide support.

FIG. 10A and FIG. 10B is another embodiment of a barrel support structure. In the illustrated embodiment, a plurality of spring-loadable protrusions extend from the interior side wall of the base 1010 towards the center of the interior and in a looping downward direction. In operation, as a barrel of a handgun is inserted through the aperture of the top in into the interior of the base 1010, the spring-loadable protrusions received the barrel and then begin to coil to receive the barrel. Thus, once the barrel is inserted, the protrusions operate to hold the barrel of the handgun in position.

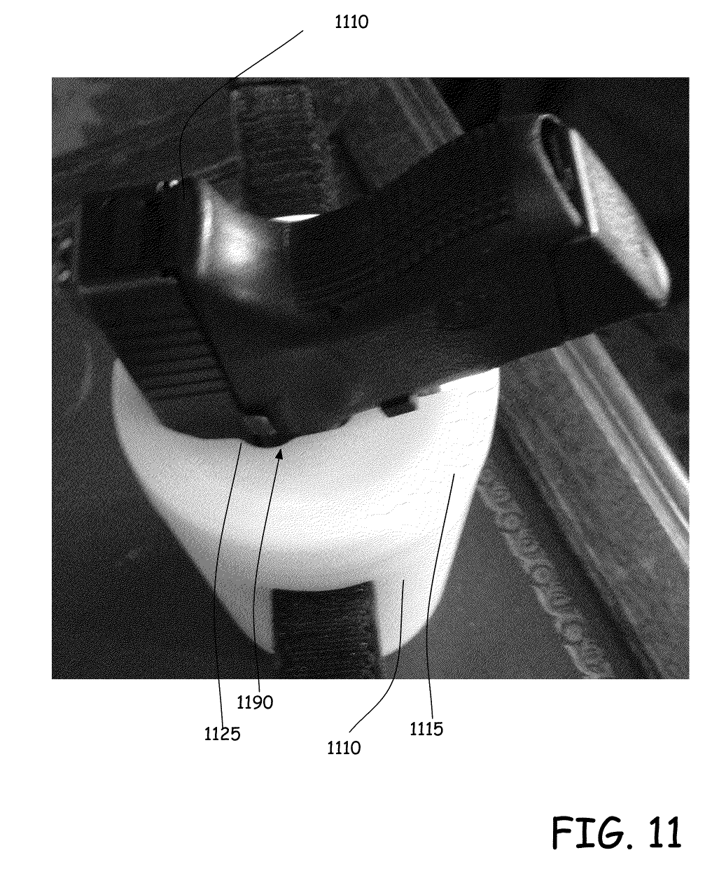

FIG. 11 is a perspective view of an exemplary embodiment of the holster with a handgun inserted into the holster. In the illustrated embodiment, the handgun 1190 is shown as its barrel and trigger guard having been inserted through the aperture 1125 of the top 1115. Thus, the barrel of the handgun is within the interior of the base 110.

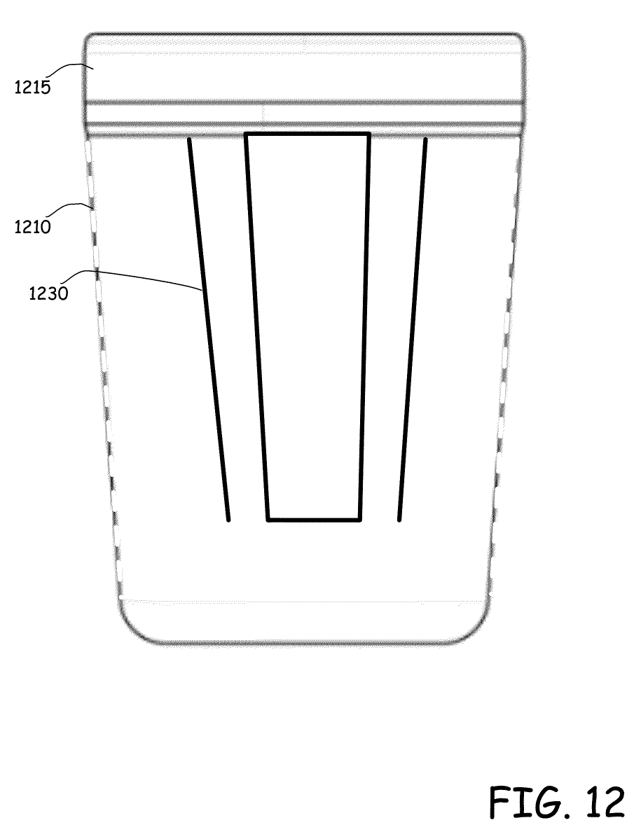

FIG. 12 is a conceptual diagram of another embodiment of the holster. In this embodiment, as well as variants thereof, the top 1215 and the barrel support 1230 are integrated together. In this embodiment, the top can be utilized with any base 1210 and the top can be interchanged for different handgun types. Thus, it will be appreciated that a wide variety of barrel support structures could be attached either to the interior of the base, the underside of the top, or a combination of both. For example, the a top configured to be a holster for a handgun can be configured to fit onto a commercially available cup, such as a TERVIS brand cup.

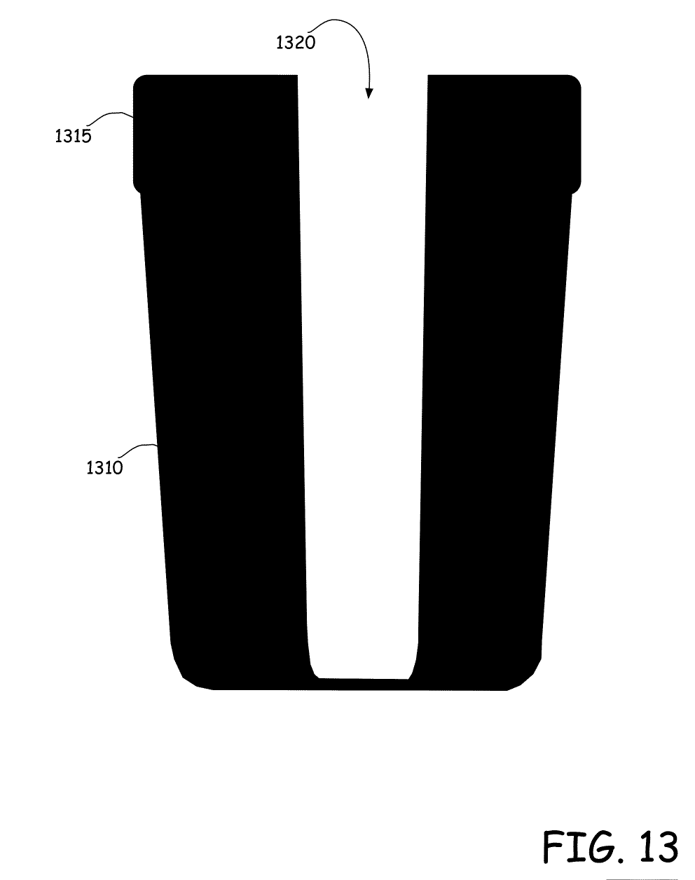

FIG. 13 is yet another embodiment of the holster. In the illustrated embodiment, the base 1310 and the top 1315 are an integral solid structure and together they define a cavity 1320 for receiving the barrel of a handgun. In this embodiment, it is clear that the interior of the base 1310 and the top 1315 also operate as the barrel support. Thus, the holster can be cast or milled as a single unit for receiving the handgun.

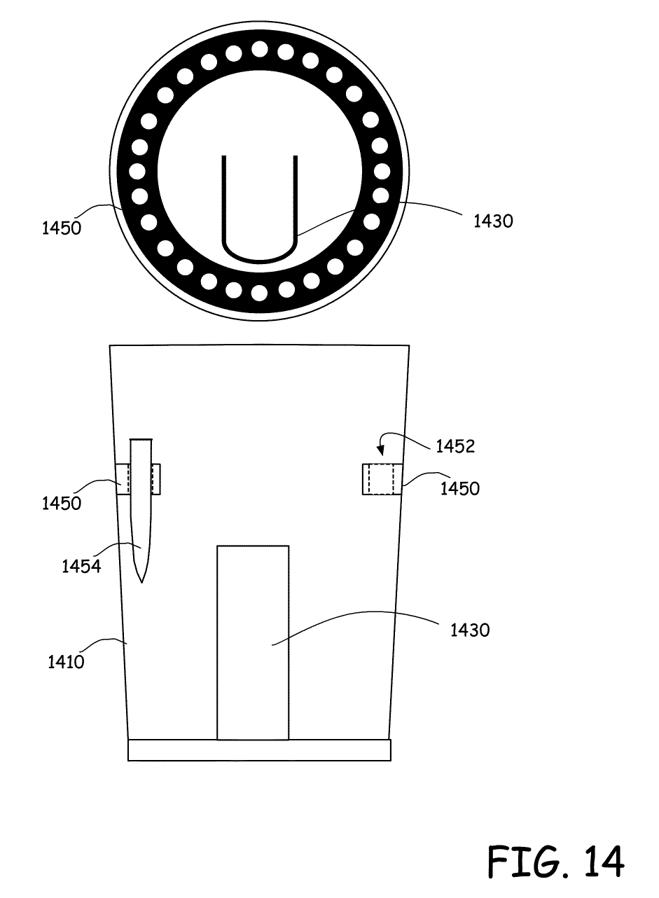

FIG. 14 is an illustration of another feature that may be incorporated into various embodiments of the handgun holster. In the illustrated embodiment, the base 1410 is shown as including a “C” shaped barrel support 1430. In addition, a ring 1450 is inserted into the interior of the base 1410 and rest against or is adjoined and or adhered to the interior wall of the base 1410 preferable above the top of the barrel support 1430. The ring 1450 includes a plurality of apertures 1452 that can be placed along the ring or at a single section of the ring. The apertures have a diameter such that they can receive a bullet of the appropriate caliber of the handgun. Thus, extra ammunition can be stored within the holster, then the top can be placed onto the holster and then the holster used for storage of the handgun.

Further, looking at the embodiment of FIG. 14 as well as other embodiments, it will be appreciated that a wide variety of configurations can be employed for a wide variety of embodiments. As previously described, the barrel support can be molded into the base or inserted into the base and attached or formed on a plate that can be inserted into the base. Thus, generic barrel supports that can interface with a wide variety of handguns can be utilized and/or specific barrel supports particularly adapted for a particular handgun can be utilized. In some embodiments, the bottom of the base can be removed from the base to facilitate changing out of various barrel supports that can be mounted to the bottom of the base.

Likewise, the ammunition holder depicted in FIG. 14 can take on a wide variety of forms. For instance, different aperture sized may be used for different caliber ammunition. Thus, the ring 1450 can be removed and replaced with a different ring if a different handgun is being stored in the holster. In addition, the ring may include apertures for different calibers and thus, various handguns can be stored within the holster and ammunition for each potential handgun can be stored and made available within the base. Further, in some embodiments a ring and barrel support structure can be sold separately, configured in kits for different handguns.

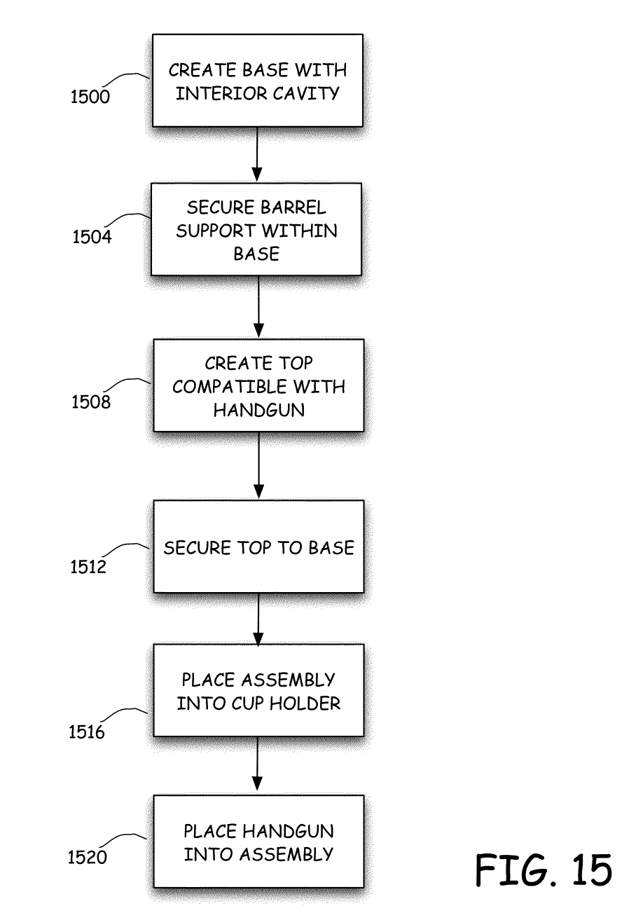

FIG. 15 is a flow diagram illustrating a method for storing a handgun within a vehicle. The method comprises creating a base with an interior cavity that can receive the barrel of the handgun 1500. In addition, a barrel support structure is secured within the base 1504, or alternatively to a top, such that when the barrel of a handgun is inserted into the base, the barrel support helps to hold the handgun in position. A top that is compatible with the desired handgun to be stored is created 1508. The compatibility includes creating an aperture that can receive the profile of the barrel and the trigger guard. In exemplary embodiments, the base is long enough so that the entire trigger guard and trigger reside within the base and as such, the trigger cannot be inadvertently actuated. The top is then secured to the base 1512 and thus, a holster assembly is created that includes the base, the barrel support and the top.

In operation, the holster assembly is then placed into a cup holder of a vehicle 1516. Once in position, a handgun can then be inserted into the holster assembly. The end of the barrel of the handgun is placed through the aperture of the top and slid into the interior of the base such that the barrel interfaces with the barrel support 1520. In some embodiments, the process may include securing straps or other fastening elements to the base and then securing the handgun into position by using the fastening elements. In this position, the grip of the handgun is visible and readily accessible. A user can retrieve the handgun easily but grabbing the grip and lifting the handgun out of the holster assembly.

The various embodiments can be manufactured from a variety of materials and in a variety of manners. Thus, embodiments can be injection molded, construed, cast, etc. The embodiments can be fabricated from plastic, wood, metal, rubber, etc.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. An apparatus for receiving and holding a handgun, the apparatus comprising:
a base that defines a cavity for receiving a portion of the handgun;
a barrel support element positioned within the cavity of the base and is immobile in relationship to the base; and
a top that is positioned above the base, the top defining an aperture through which the barrel of the handgun can penetrate when being positioned into the barrel support element;
wherein the base is configured to be inserted into a cup-holder of a vehicle.

2. The apparatus of claim 1, wherein the base and the top are removeably attached.

3. The apparatus of claim 1, wherein the base includes a weight to help secure the base within the cup-holder.

4. The apparatus of claim 1, wherein the base is sufficiently tall to enable the trigger portion of the handgun to penetrate through the aperture of the top.

5. The apparatus of claim 1, wherein the base is cup-shaped and the barrel support is removably attached to the interior bottom of the base.

6. The apparatus of claim 1, wherein the base is cup-shaped and the barrel support is removably attached to one or more interior surfaces of the base.

7. The apparatus of claim 6, wherein different configurations of the barrel support can be attached within the base to accommodate different types of handguns.

8. The apparatus of claim 1, wherein the top defines an aperture at is configured to receive the barrel of the handgun and at least a substantial portion of the trigger guard.

9. The apparatus of claim 2, wherein the top is removably attachable to the base and different tops can be attached to the base to accommodate different types of handguns.

10. The apparatus of claim 1, wherein the barrel support is integral to the top.

11. A method for storing of a handgun but in a manner that provides easy access, the method comprising the actions of:
placing a base into a cup-holder, the base defining an interior cavity;
placing a barrel support into the interior cavity of the base;
placing a top onto the base, the top defining an aperture through which a barrel of a handgun can penetrate through and to provide access to the barrel support; and
placing a handgun through the aperture of the top such that the barrel enters the interior cavity of the base and is held in position by the barrel support.

12. The method of claim 11, wherein the action of placing a barrel support into the base comprises integrally forming a base that includes the barrel support.

13. The method of claim 11, wherein the action of placing a barrel support into the base comprises removably attaching the barrel support to an interior surface of the base.

14. The method of claim 13, wherein one of a plurality of different barrel supports can be removably attached to an interior surface of the base to accommodate different handgun types.

15. The method of claim 11, wherein the action of placing a barrel support into the base comprises affixing the barrel support to the top prior to placing the top onto the base.

16. The method of claim 15, wherein one of a plurality of different barrel supports can be affixed to the top to accommodate different handgun types.

17. The method of claim 15, wherein different handgun types can be stored by performing the action of attaching a particular adapter to the barrel support, the adapter being suitable for configuring the barrel support to accommodate a particular handgun type.

18. The method of claim 11, wherein one of a plurality of different tops, with each top defining a different aperture shape, can be attached to the top of the base to accommodate different handguns.

19. The method of claim 11, wherein the base, barrel support and the aperture of the top are configured such that the action of placing a handgun through the aperture further comprises placing the barrel and a substantial portion of the trigger guard through the aperture and into the interior cavity such that the trigger is not accessible while the handgun is stored.

20. An apparatus for receiving and holding a handgun, the apparatus comprising:
a base that defines a cavity for receiving a portion of the handgun;
a barrel support element positioned within the cavity of the base and is affixed to one or more interior surfaces of the base; and
a top that is positioned above the base, the top defining an aperture through which the barrel of the handgun can penetrate when being positioned into the barrel support element;
wherein the base, barrel support, top and the aperture defined by the top are configures such that a substantial portion of the barrel and the trigger guard of the handgun, and the entire trigger of the handgun can be placed entirely within the cavity of the base.
